(19) United States
(12) Patent Application Publication
(10) Pub. No.: US 2026/0289442 A1
(43) Pub. Date: Sep. 24, 2026

(54) READING DEVICE, READING METHOD, AND NON-TRANSITORY COMPUTER READABLE MEDIUM

(71) Applicant: NEC Corporation, Tokyo (JP)

(72) Inventors: Yukikazu YAMAOKA, Tokyo (JP); Kei SATO, Tokyo (JP); Miku YANAGIMOTO, Tokyo (JP)

(73) Assignee: NEC Corporation, Tokyo (JP)

(21) Appl. No.: 19/441,166

(22) Filed: Jan. 6, 2026

(30) Foreign Application Priority Data
Mar. 24, 2025 (JP) 2025-048203

(51) Int. Cl. G06Q 10/0631; G06K 7/10

(52) U.S. Cl. CPC G06Q 10/06311; G06K 7/10445

(57) ABSTRACT

A reading device according to the present disclosure includes a storage unit, an acquisition unit, a specification unit, and an extraction unit. The storage unit stores work identification information for identifying work content and necessary item information indicating a target item included in a target label necessary for execution of the work content in association with each other. The acquisition unit acquires scan information indicating information obtained by collectively reading a plurality of labels attached to an article. The specification unit acquires work information related to work to be worked on by the worker, and specifies work identification information relevant to the work information. The extraction unit detects a target label from a plurality of labels of the scan information based on the target item information associated with the specified work identification information, and extracts description contents of the target item from the target label as the target information.

### INCORPORATION BY REFERENCE

This application is based upon and claims the benefit of priority from Japanese patent application No. 2025-048203, filed on Mar. 24, 2025, the disclosure of which is incorporated herein in its entirety by reference.

### TECHNICAL FIELD

The present disclosure relates to a reading device, a reading method, and a non-transitory computer readable medium.

### BACKGROUND ART

In the logistics industry where there are a plurality of hierarchies and companies such as procurement, manufacturing, distribution, and sales, formats and description contents of labels used to indicate information regarding transportation are not unified. Therefore, a worker at a distribution site needs to find a target label from a plurality of labels in order to read information necessary for work.

### SUMMARY

JP 2003-112826 A describes reading and decoding label information, and displaying and outputting only label information of an item associated with a work in charge among items of the label information.

However, JP 2003-112826 A does not describe detecting a target label from among mixed labels and extracting description contents of a target item included in the target label. Therefore, the delivery information management system described in JP 2003-112826 A cannot detect a target label from among mixed labels and read description contents of a target item included in the target label.

In view of the above-described problem, an example object of the present disclosure is to provide a reading device or the like that detects a label suitable for a work content from a plurality of mixed labels and suitably reads a content of an item suitable for the work content included in the label.

A reading device according to an example aspect of the present disclosure includes a storage unit, an acquisition unit, a specification unit, and an extraction unit. The storage unit stores work identification information for identifying work content and necessary item information indicating a target item included in a target label necessary for execution of the work content in association with each other. The acquisition unit acquires scan information indicating information obtained by collectively reading a plurality of labels attached to an article. The specification unit acquires work information related to work to be worked on by the worker, and specifies work identification information relevant to the work information. The extraction unit detects a target label from a plurality of labels of the scan information based on the target item information associated with the specified work identification information, and extracts description contents of the target item from the target label as the target information.

In a reading method according to an example aspect of the present disclosure, a computer executes the following processing. The computer stores work identification information for identifying work content and necessary item information indicating a target item included in a target label necessary for execution of the work content in association with each other. The computer acquires scan information indicating information obtained by collectively reading a plurality of labels attached to an article. The computer acquires work information related to work to be worked on by the worker, and specifies work identification information relevant to the work information. The computer detects a target label from a plurality of labels of the scan information based on the target item information associated with the specified work identification information, and extracts description contents of the target item from the target label as the target information.

A program according to an example aspect of the present disclosure causes a computer to execute the following processing. The computer stores work identification information for identifying work content and necessary item information indicating a target item included in a target label necessary for execution of the work content in association with each other. The computer acquires scan information indicating information obtained by collectively reading a plurality of labels attached to an article. The computer acquires work information related to work to be worked on by the worker, and specifies work identification information relevant to the work information. The computer detects a target label from a plurality of labels of the scan information based on the target item information associated with the specified work identification information, and extracts description contents of the target item from the target label as the target information.

According to the present disclosure, it is possible to provide a reading device, a reading method, and a program for detecting a label suitable for a work content from a plurality of mixed labels and suitably reading content of an item suitable for the work content included in the label.

### BRIEF DESCRIPTION OF DRAWINGS

The above and other aspects, features and advantages of the present disclosure will become more apparent from the following description of certain exemplary embodiments in conjunction with the accompanying drawings, in which:

FIG. 1 is a first block diagram of a reading device according to the present disclosure;

FIG. 2 is a first flowchart of a reading method according to the present disclosure;

FIG. 3 is a second block diagram of the reading device according to the present disclosure;

FIG. 4 is an example of an article to which a plurality of labels are attached;

FIG. 5 is a second flowchart of the reading method according to the present disclosure;

FIG. 6 is a third block diagram of the reading device according to the present disclosure;

FIG. 7 is an example of a target label according to the present disclosure; and

FIG. 8 is a block diagram exemplifying a hardware configuration of a computer.

### EXAMPLE EMBODIMENTS

Hereinafter, the present disclosure will be described through example embodiments, but the disclosure according to the claims is not limited to the following example embodiments. Not all the configurations described in the example embodiment are essential as means for solving the problem. To clarify description, in the following description and drawings, omission and simplification are made as appropriate. In each drawing, the same elements are denoted by the same reference numerals, and repetitive description is omitted as necessary.

### First Example Embodiment

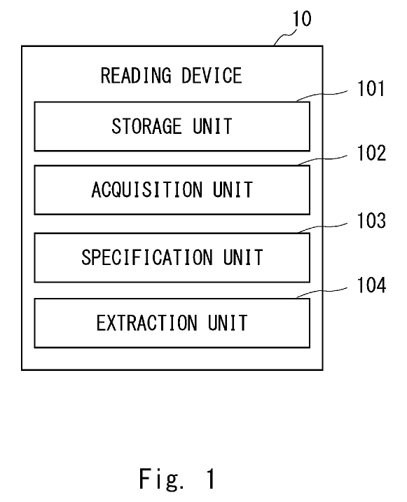

FIG. 1 is a first block diagram of a reading device 10 according to the present disclosure. The reading device 10 collectively reads contents included in a plurality of labels attached to an article, and extracts a label suitable for work contents and contents of items included in the label. The reading device 10 is used, for example, in processes such as incoming inspection, putting in shelves, picking, taking stock, shipping inspection, and packing in a warehouse. The reading device 10 is not limited thereto, and may be used for inventory management, tracking, or the like. The reading device 10 includes a storage unit 101, an acquisition unit 102, a specification unit 103, and an extraction unit 104.

The storage unit 101 stores work identification information for identifying work content and target item information indicating a target item included in a target label necessary for execution of the work content in association with each other. The work content is a content of work performed by the worker. In the case of in-warehouse work, the work content is, for example, incoming inspection, putting in shelves, picking, taking stock, shipping inspection, packing, or the like. Here, the work content is not limited to one process, and may extend over a plurality of processes. The work identification information is information for identifying work content in the device. The work identification information is, for example, text information indicating the name of the work, an identification number or an identification code assigned to each work content, or the like.

The target label is a label including a target item. The target item is an item including information necessary for work management. The target item may be one or more. The target item may be some items or all items included in the target label. The target item is, for example, an item such as a lot, a serial number, a product identifier (ID), a country of origin, or a manufacturing date. The target item information indicates, for example, a target label based on an appearance feature. The appearance feature is, for example, the number of items or a combination of items included in the target label, the shape of the target label, the color of the target label, a character string or a mark given to the label, or the like.

The acquisition unit 102 acquires scan information indicating information obtained by collectively reading a plurality of labels attached to an article. The label reading method is, for example, optical. The reading method is not limited to optical, but may be electronic, magnetic, or the like. Here, reading a label is also referred to as scanning. The acquisition unit 102 may include an acquisition means or a communication means (not illustrated). The acquisition means is a means for reading a label. The communication means is a means for being connected to an external device (not illustrated) and acquiring scan information via communication. Here, the scan information is, for example, image information including a plurality of labels, list data including description contents in one or a plurality of items of the plurality of labels, or the like. The scan information is not limited thereto, and may be image information for each label, text information of description contents in one or a plurality of items for each label, or the like.

The specification unit 103 acquires work information related to work to be worked on by the worker, and specifies work identification information relevant to the work information. For example, the worker reads a plurality of labels attached to the article collectively and performs the work. Alternatively, the worker performs the work in the periphery where the work of collectively reading the plurality of labels is performed. The work information indicates work content of work to be worked on by the worker. The work information may be any information as long as it can identify the work content of the work to be worked on by the worker. The work information is, for example, text information indicating the name of the work, an identification number or an identification code assigned to each work content, or the like.

The extraction unit 104 detects a target label from a plurality of labels of the scan information based on the target item information associated with the specified work identification information. For example, the extraction unit 104 detects the target label based on the feature information included in the target item information. The extraction unit 104 is not limited thereto, and may detect the target label including the target item based on the number of items included in the label, a combination of items, or the like.

Next, the extraction unit 104 extracts the description content of the target item from the target label as the target information. The target information is information necessary for management of work performed by the worker. The target information is, for example, information such as a lot, a serial number, a product ID, a country of origin, or a manufacturing date.

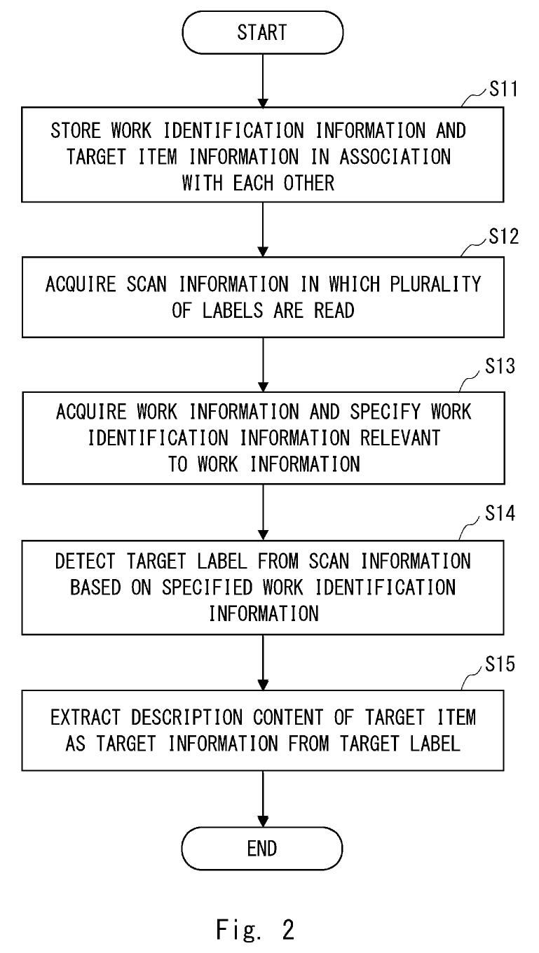

FIG. 2 is a first flowchart of a reading method according to the present disclosure. FIG. 2 illustrates a first flow of a reading method of the reading device 10. The first reading method performed by the reading device 10 includes steps S11 to S15.

In step S11, the storage unit 101 of the reading device 10 stores work identification information for identifying work content and target item information indicating a target item included in a target label necessary for execution of the work content in association with each other. Here, the work content is a content of work performed by the worker. The target label is a label including a target item. The target item is an item including information necessary for work management.

In step S12, the acquisition unit 102 of the reading device 10 acquires scan information indicating information obtained by collectively reading a plurality of labels attached to an article. The acquisition unit 102 may include an acquisition means or a communication means (not illustrated) in order to acquire the scan information. The scan information is, for example, image information including a plurality of labels, list data including description contents in one or a plurality of items of the plurality of labels, or the like.

In step S13, the specification unit 103 of the reading device 10 acquires work information related to work to be worked on by the worker, and specifies work identification information relevant to the work information. The work information indicates work content of work to be worked on by the worker. The work information may be any information as long as it can identify the work content of the work to be worked on by the worker.

In step S14, the extraction unit 104 of the reading device 10 detects the target label from the plurality of labels of the scan information based on the target item information associated with the specified work identification information. For example, the extraction unit 104 detects the target label based on the feature information included in the target item information.

In step S15, the extraction unit 104 extracts the description content of the target item from the target label as the target information. The target information is information necessary for management of work performed by the worker. The target information is, for example, information such as a lot, a serial number, a product ID, a country of origin, or a manufacturing date. Upon completion of step S15, the reading device 10 ends the processing related to the reading method.

As described above, the reading device 10 stores the work identification information and the target item information in association with each other, and extracts description contents of the target item indicated by the target item information relevant to the work information from the scan information obtained by collectively reading a plurality of labels. Accordingly, the reading device 10 can detect a label suitable for the work content from a plurality of mixed labels, and can suitably read the content of an item suitable for the work content included in the label.

The reading device 10 may include a processor and a storage device as components not illustrated. The storage device included in the reading device 10 includes, for example, a storage device including a nonvolatile memory such as a flash memory or a solid state drive (SSD). In this case, the storage device stores a computer program (hereinafter, also simply referred to as a program) for executing the above-described method. The processor reads the computer program from the storage device into a buffer memory such as a Dynamic Random Access Memory (DRAM), and executes the program.

Each configuration of the reading device 10 may be achieved by dedicated hardware. Some or all of the constituent components may be implemented by general-purpose or dedicated circuitry, a processor, or the like, or a combination thereof. These may be configured by a single chip, or may be configured by a plurality of chips connected via a bus. Some or all of the components of each device may be implemented by a combination of a program and the above-described circuitry or the like. The processor is any of various kinds of processors such as a central processing unit (CPU), a graphics processing unit (GPU), or a field-programmable gate array (FPGA). At least a part of the processing executed by the reading device 10 may be provided as software as a service (SaaS). The description relating to the configuration described here can also be applied to other systems described below in the present disclosure.

Normally, the reading device 10 is configured in a single terminal including a reading means, but is not limited thereto. The reading device 10 may be, for example, a server device wirelessly connected to the reading means, a cloud system implemented by distributed processing between a plurality of devices, or the like. The reading device 10 may be implemented by an external device (not illustrated) on a network (not illustrated) that connects some components such as the storage unit 101.

### Second Example Embodiment

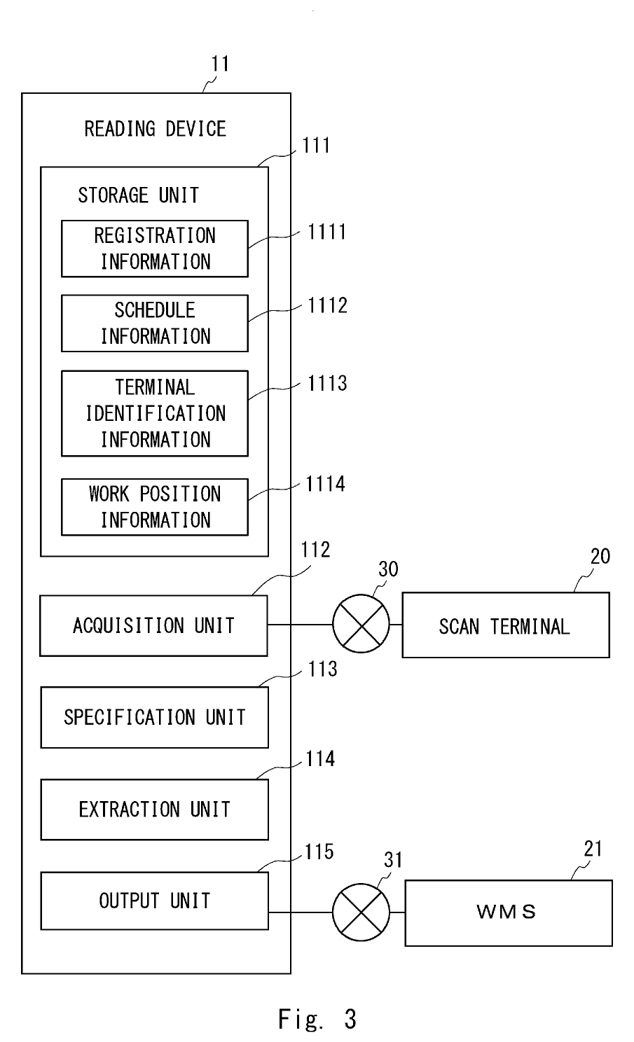

FIG. 3 is a second block diagram of a reading device 11 according to the present disclosure. FIG. 3 illustrates a configuration of the reading device 11. The reading device 11 specifies work information using at least one of a plurality of pieces of information related to work and extracts target information. Here, the reading device 11 is used for work in a warehouse managed by a warehouse management system. The warehouse management system is also called a warehouse management system (WMS).

The reading device 11 has partially the same configuration as the reading device 10 described with reference to FIG. 1. Therefore, description of a configuration that performs processing overlapping with the reading device 10 is omitted. The reading device 11 is connected to a scan terminal 20 via a first network 30. The reading device 11 is connected to a WMS 21 via a second network 31. The reading device 11 includes a storage unit 111, an acquisition unit 112, a specification unit 113, an extraction unit 114, and an output unit 115.

The scan terminal 20 is a terminal that reads a label. The scan terminal 20 optically reads a label, for example. In general, the scan terminal 20 acquires an image of a label by a camera (not illustrated), and reads scan information by using image recognition software or the like for the image of the label. The scan terminal 20 may acquire image information of a label as scan information. The label reading method of the scan terminal 20 is not limited thereto, and a laser or the like may be used to acquire image information of a label or an image recognition result as scan information. The scan terminal 20 may read the label not only optically but also electronically or magnetically.

The scan terminal 20 may be a handy terminal or an installation type terminal. In a case where the scan terminal 20 is an installation type terminal, the scan terminal may be designed so that labels attached to a plurality of surfaces of an article can be read at the same time. In this case, the scan terminal 20 may be installed on a line and automatically read a plurality of labels.

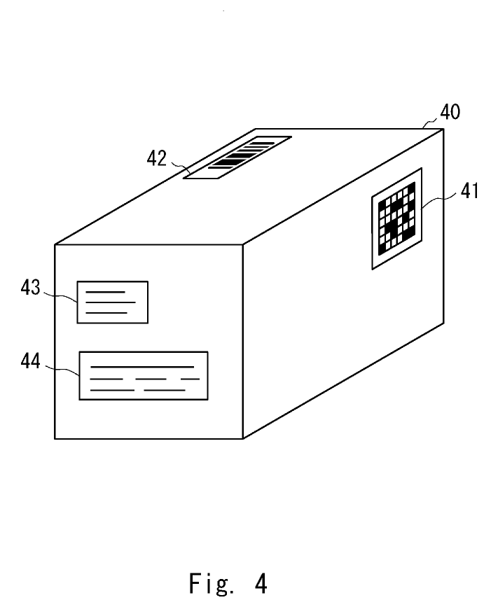

FIG. 4 is an example of an article 40 with a plurality of labels attached thereto. FIG. 4 illustrates a state in which a plurality of labels to be read is attached to the article 40. A first label 41, a second label 42, a third label 43, and a fourth label 44 are attached to the article 40.

Here, in the first label 41, description contents of items are described in a two-dimensional code. Examples of the two-dimensional code include a QR code (registered trademark). The second label 42 describes description contents of items in a one-dimensional code. The one-dimensional code is also referred to as a barcode. The third label 43 and the fourth label 44 describe description contents of items in text, a character string, or the like.

In this case, the worker reads all the labels of the first label 41, the second label 42, the third label 43, and the fourth label 44 attached to each surface of the article 40 using the scan terminal 20. The worker only needs to read all the labels at once, and the number of times of reading the labels is not limited. For example, the worker may read all the labels at one time, or may read all the labels continuously in a plurality of times. The worker may continuously read all the labels one by one. Here, “continuously” refers to working without interruption. For example, if there is no empty time for several minutes, the scan terminal 20 treats it as a continuous operation and treats it as the same scan information. The scan terminal 20 may end the reading work and determine the scan information according to the operation of the worker. The scan terminal 20 transmits scan information generated after completion of a series of reading to the reading device 11.

Referring again to FIG. 3, the first network 30 connects the reading device 11 and the scan terminal 20. The first network 30 is generally a wireless network, but may be a wired network. In a case where the first network 30 is a wireless network, the first network 30 is configured using, for example, Bluetooth (registered trademark), WiFi (registered trademark), or the like.

The WMS 21 is a management system that manages a warehouse where workers work. The WMS 21 is connected to, for example, a presentation means (not illustrated), and presents information necessary for work to a worker. The presentation means is, for example, a monitor, a speaker, or the like. The presentation means may be installed in a warehouse managed by the WMS 21, may be provided in a personal terminal of the worker, or may be provided in the scan terminal 20. The personal terminal is, for example, a smartphone, a personal computer (PC), a tablet, or the like. The connection method is, for example, a wireless network using Bluetooth (registered trademark), WiFi (registered trademark), or the like, but is not limited thereto.

The second network 31 connects the reading device 11 and the WMS 21. The second network 31 is, for example, a wireless network or a wired network. In a case where the second network 31 is a wireless network, the second network 31 is configured using, for example, Bluetooth (registered trademark), WiFi (registered trademark), or the like. The second network 31 may be common to the first network 30.

The target item information stored in the storage unit 111 includes feature information indicating the format of the target label. The feature information is used to detect the target label. Here, the format is the appearance of the label or the configuration of the item included in the label. The feature information is information indicating at least one of an appearance feature of the target label and a configuration of an item included in the target label as the format of the target label.

Here, the appearance feature is a feature for describing the appearance of the label. The appearance feature is, for example, a display method of items included in the target label, arrangement of items, a shape of the target label, a color of the target label, label identification information given to the label, or the like. The display method of the item is how the item indicates the description content. The display method of the item is, for example, text, a sequence of numbers, a one-dimensional code, a two-dimensional code, or the like. The label identification information is information indicating the type or affiliation of the label. The label identification information is, for example, a character string, a logo mark, a one-dimensional code, a two-dimensional code, or the like described in the target label. The label identification information may be information indicated by a one-dimensional code or a two-dimensional code included in the target label. The configuration of the item indicates the number and type of items included in the target label.

The storage unit 111 further stores registration information 1111 in which the worker is identifiably registered in association with the work identification information. The registration information 1111 is information used for verification of workers. The registration information 1111 is, for example, designation of a worker, a worker ID assigned to the worker, biometric information for biometric authentication of the worker, or the like. The worker ID is, for example, an identification number or an identification code of the worker. The biometric information for biometric authentication is, for example, a fingerprint, a palm print, a face image, an iris, a voiceprint, or the like. Accordingly, the reading device 11 can read the work identification information indicating the work content which the specified worker is in charge of.

The storage unit 111 further stores schedule information 1112 indicating a work schedule for each worker in association with the registration information 1111. The work schedule is a schedule of which work content the worker is in charge of at a specific time. The schedule information 1112 indicates, for example, work contents in the morning and the afternoon for each worker. The schedule information 1112 is not limited thereto, and may be any information as long as the work content changing with time can be confirmed. Specifically, the schedule information 1112 may be information of a time unit of work content that the worker is in charge of. According to this, the reading device 11 can read the work identification information indicating the work content that the specified worker is currently in charge of even in a case where the work content that the worker is in charge of changes with time.

Here, the storage unit 111 may further store terminal identification information 1113 of a read terminal that reads a plurality of labels in association with the work identification information. The read terminal is, for example, the scan terminal 20 or the like. The terminal identification information 1113 is information used for verification of a read terminal used by the worker. Accordingly, in a case where the work content and the read terminal are associated with each other, the reading device 11 can specify the work content based on the terminal identification information 1113. The case where the work content and the read terminal are associated with each other is, for example, a case where a specific read terminal is permanently installed in a workplace relevant to the work content, or a case where a specific read terminal is allocated to a worker whose work content is fixed.

The storage unit 111 may further store work position information 1114 indicating the work area for each work content in association with the work identification information. The work area is a range in which the worker executes the work content. The work position information 1114 is expressed by, for example, position information in the warehouse. Alternatively, the work position information 1114 may be information indicating the inside and outside of the warehouse. The work position information 1114 is not limited thereto, and may be expressed by signal strength of a radio signal. The work position information 1114 may be expressed by information acquired from a sensor of a device used for work. Here, the sensor is, for example, a temperature sensor, an acceleration sensor, an illuminance sensor, or the like.

The acquisition unit 112 communicates with the scan terminal 20 via the first network 30. The acquisition unit 112 acquires scan information from the scan terminal 20. The acquisition unit 112 may acquire the terminal identification information of the scan terminal 20 via communication with the scan terminal 20. Here, the scan terminal 20 is relevant to the read terminal that has generated the scan information. Accordingly, in a case where the scan terminal 20 is associated with the work content, the reading device 11 can specify the work content from the terminal information of the scan terminal 20.

The acquisition unit 112 acquires authentication information regarding authentication of the worker. The acquisition unit 112 acquires authentication information via an authentication means (not illustrated). The authentication means verifies the authentication information input by the worker with the registration information to authenticate the worker. The authentication information input by the worker is information registered as registration information. The authentication information is, for example, designation of a worker, a worker ID assigned to the worker, biometric information for biometric authentication of the worker, or the like. The authentication means receives an input of authentication information by a worker using a camera, a keyboard, a voice sensor, or the like. The authentication means is provided in, for example, the reading device 11, the scan terminal 20, or the WMS 21. The authentication means is not limited thereto, and may be provided in an external device and communicate with the acquisition unit 112. Accordingly, the reading device 11 can read the relevant registration information based on the authentication information of the worker.

Further, the acquisition unit 112 may acquire selection information indicating the work content selected by the worker. The acquisition unit 112 acquires the selection information via a selection acceptance means (not illustrated). The selection acceptance means accepts selection of work content from the worker using a user interface, and generates selection information indicating a selection result. The user interface presents a work content candidate using, for example, a monitor, a speaker, or the like, and receives selection of a worker using a mouse, a button, a keyboard, a touch panel, a voice sensor, or the like. The selection acceptance means is provided in, for example, the reading device 11, the scan terminal 20, or the WMS 21. The selection acceptance means is not limited thereto, and may be provided in an external device and communicate with the acquisition unit 112. Accordingly, the reading device 11 can specify the work content based on the selection of the worker.

The scan information acquired by the acquisition unit 112 from the scan terminal 20 may include scan position information. The scan position information is information indicating positions at which a plurality of labels has been read. The scan position information is, for example, position information in the warehouse at the time of reading the label. Alternatively, the scan position information is not limited thereto, and may be the signal strength of the radio signal at the time of reading the label. The scan position information may be signal strength at the time of reading a label acquired from a sensor (not illustrated) included in the scan terminal 20. Here, the sensor is, for example, a temperature sensor, an acceleration sensor, an illuminance sensor, or the like. The signal acquired from the sensor indicates, for example, temperature, acceleration change, illuminance, or the like. The scan terminal 20 may determine indoor and outdoor based on the signal strength from the sensor, and may use the determination result as the scan position information.

The specification unit 113 specifies the work identification information based on the authentication information and the registration information 1111. The specification unit 113 verifies the authentication information with the registration information 1111 and specifies the registration information 1111 relevant to the authentication information. Next, the specification unit 113 specifies the work identification information associated with the specified registration information 1111. Accordingly, the reading device 11 can specify the work identification information indicating the work content which the worker is in charge of from the authentication information of the worker.

The specification unit 113 further acquires the current time, and specifies the work identification information based on the authentication information, the registration information 1111, the schedule information 1112, and the current time. Accordingly, the reading device 11 can specify the work identification information indicating the work content assigned at the current time for the worker whose work content assigned in terms of time is changed.

Further, in a case where the acquisition unit 112 acquires the selection information, the specification unit 113 may specify the work identification information relevant to the work content indicated by the selection information. Accordingly, the reading device 11 can specify the work identification information indicating the work content that the worker is in charge of based on the selection of the worker.

In a case where the storage unit 111 stores the terminal identification information 1113 in association with the work identification information and the acquisition unit 112 acquires the terminal identification information of the scan terminal 20, the specification unit 113 may specify the work identification information based on the terminal identification information of the scan terminal 20. Here, the scan terminal 20 is a read terminal that has generated the scan information. Accordingly, the reading device 11 can specify the work identification information indicating the work content associated with the use of the scan terminal 20.

In a case where the storage unit 111 stores the work position information in association with the work identification information and the scan information includes the scan position information, the specification unit 113 may specify the work identification information based on the scan position information included in the scan information. Here, the scan position information is position information of a position where the scan terminal 20 has read the label. Accordingly, the reading device 11 can specify the work identification information indicating the work content associated with the scan position of the scan terminal 20.

The extraction unit 114 detects a target label from a plurality of labels based on the target item information associated with the work identification information specified by each method and the scan information, and extracts description contents of the target item as the target information.

Here, the extraction unit 114 detects the target label from the plurality of labels included in the scan information based on the feature information. The feature information is information indicating the format of the target label included in the target item information. The extraction unit 114 detects a label matching the feature information using, for example, image authentication software or a vision language model (VLM) learned for detection. The VLM is generative artificial intelligence (AI) relevant to an image and language data. Accordingly, the extraction unit 114 can detect the target label from the label format. Therefore, the reading device 11 can read the target information while suppressing the cost required to read the details of the items included in all the labels.

Referring again to FIG. 4, the extraction unit 114 detects the target label from the first label 41, the second label 42, the third label 43, and the fourth label 44 attached to the article 40. Here, assuming that the first label 41 is a target label, the description format of the description content of the feature information is, for example, a two-dimensional code. Here, the extraction unit 114 checks the description format of each label, and detects the first label 41 whose description format is a two-dimensional code as a target label.

In a case where a plurality of labels relevant to the format indicated by the feature information is detected, the extraction unit 114 detects the target label from among the plurality of candidate labels based on the configuration of the item included in the candidate label or the description content for each item. The extraction unit 114 may include a presentation means (not illustrated), extract description contents of the target item for each of the plurality of candidate labels, and present the plurality of candidate labels and the description contents to the worker. The presentation means is, for example, a monitor or the like.

Referring again to FIG. 3, the output unit 115 is connected to the WMS 21 via the second network 31. The output unit 115 outputs the extracted target information to the WMS 21. Accordingly, the reading device 11 can suitably input the information about the incoming and outgoing with respect to the WMS 21.

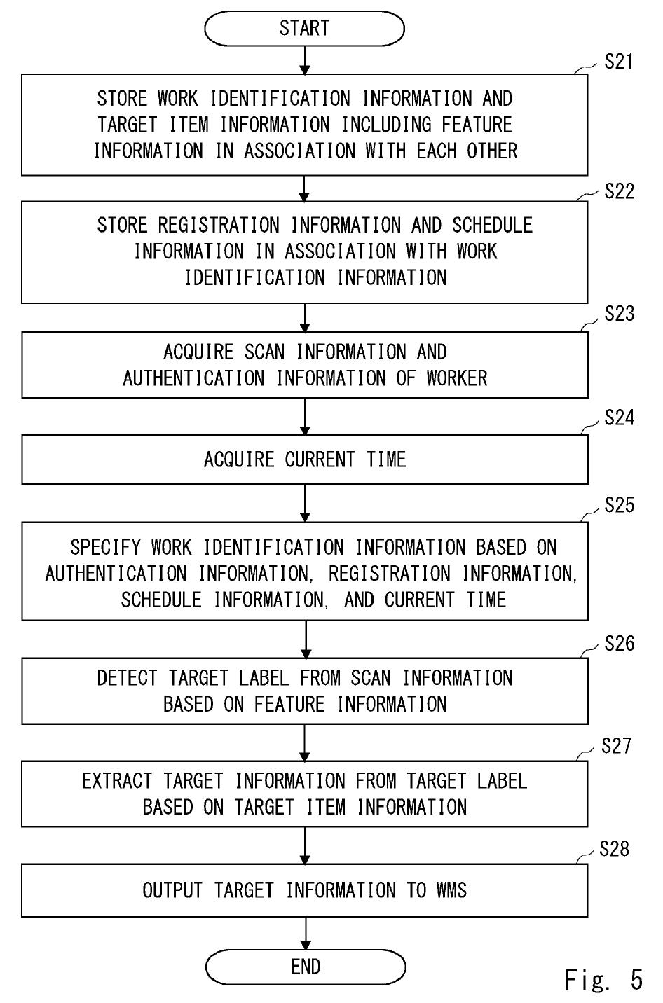

FIG. 5 is a second flowchart of the reading method according to the present disclosure. FIG. 5 illustrates a second flow of the reading method of reading device 11. The second reading method performed by the reading device 11 includes steps S21 to S28.

In step S21, the storage unit 111 of the reading device 11 stores the target item information including the work identification information for identifying the work content and the feature information indicating the format of the target label in association with each other. Here, the feature information is information indicating at least one of an appearance feature of the target label and a configuration of an item included in the target label as the format of the target label.

In step S22, the storage unit 111 stores the registration information and the schedule information in association with the work identification information. Here, the registration information is information registered so that the worker can be identified, and is information used for verification of the worker. The registration information is, for example, designation of a worker, a worker ID assigned to the worker, biometric information for biometric authentication of the worker, or the like. The schedule information is information indicating a work schedule for each worker. The work schedule is a schedule of which work content the worker is in charge of at a specific time.

In step S23, the acquisition unit 112 of the reading device 11 acquires scan information and worker authentication information from the scan terminal 20. The acquisition unit 112 acquires authentication information via an authentication means (not illustrated). The authentication means verifies the authentication information input by the worker with the registration information to authenticate the worker. The authentication information input by the worker is information registered as registration information. The authentication information is, for example, designation of a worker, a worker ID assigned to the worker, biometric information for biometric authentication of the worker, or the like.

In step S24, the specification unit 113 of the reading device 11 acquires the current time. In step S25, the specification unit 113 specifies the work identification information based on the authentication information, the registration information, the schedule information, and the current time. Accordingly, the reading device 11 can specify the work identification information indicating the work content assigned at the current time for the worker whose work content assigned in terms of time is changed.

In step S26, the extraction unit 114 of the reading device 11 detects the target label from the plurality of labels included in the scan information based on the feature information. The feature information is information indicating the format of the target label included in the target item information associated with the specified work identification information. The extraction unit 114 detects a label matching the feature information using, for example, image authentication software or a VLM learned for detection.

In step S27, the extraction unit 114 extracts the target information from the detected target label based on the target item information associated with the specified work identification information. Here, the target information is the description content in the target item of the target label. Based on the target information, the worker performs work such as inspection or shipment.

In step S28, the output unit 115 of the reading device 11 outputs the extracted target information to the WMS 21. Accordingly, the reading device 11 can suitably input the information about the incoming and outgoing with respect to the WMS 21. Upon completion of step S28, the reading device 11 ends the processing related to the reading method.

As described above, the reading device 11 specifies the work identification information indicating the work content executed by the worker based on the registration information and the schedule information of the worker, detects the target label based on the feature information associated with the specified work identification information, and extracts the target information. Accordingly, the reading device 11 can detect a label suitable for the work content from a plurality of mixed labels, and can more suitably read the content of an item suitable for the work content included in the label.

Here, the description of the procedure for specifying the work identification information using the terminal identification information 1113 and the work position information 1114 is omitted. The reading device 11 may store and acquire relevant information in steps S22 and S23, and specify the work identification information using the terminal identification information 1113 and the work position information 1114 by using the relevant information in step S25.

The feature information indicating the format of the target label is defined and input in advance by the administrator, for example. Alternatively, the feature information indicating the format of the target label may be automatically defined and input according to a business partner company, article classification, or the like using machine learning.

### Third Example Embodiment

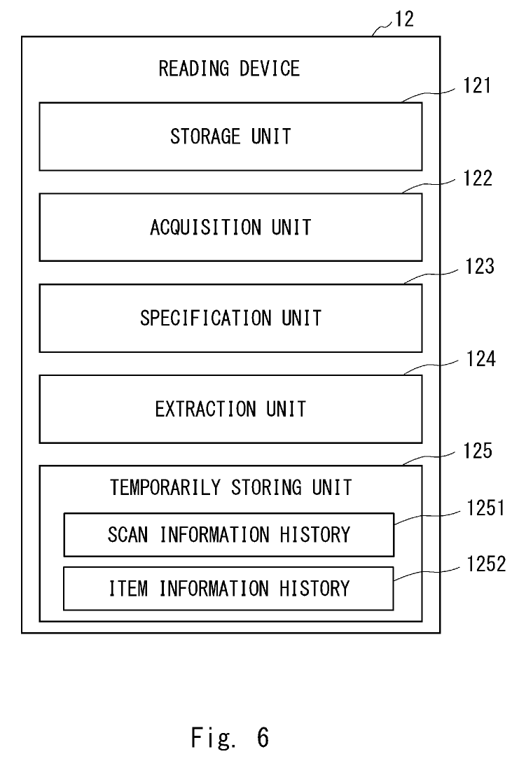

FIG. 6 is a third block diagram of a reading device 12 according to the present disclosure. FIG. 6 illustrates a configuration of the reading device 12. The reading device 12 temporarily stores past scan information and information of items included in the target label specified in the scan information history. The reading device 12 has partially the same configuration as the reading device 10 described with reference to FIG. 1. Therefore, description of a configuration that performs processing overlapping with the reading device 10 is omitted. The reading device 12 includes a storage unit 121, an acquisition unit 122, a specification unit 123, an extraction unit 124, and a temporarily storing unit 125. The storage unit 121, the acquisition unit 122, the specification unit 123, and the extraction unit 124 of the reading device 12 first acquire the scan information, detect the target label, and extract the target information, as described with reference to FIG. 1.

The temporarily storing unit 125 temporarily stores a scan information history 1251 which is scan information acquired in the past in association with an item information history 1252 indicating description contents of an item including at least a target item of a target label specified in the scan information. Here, the scan information acquired in the past is scan information acquired at the time of reading the label in the upstream work processes. The item information history 1252 is information including description contents of each item included in the target label detected from the past scan information. The item information history 1252 includes at least description contents in the target item. The item information history 1252 may include description contents of some items included in the detected target label, or may include description contents of all items.

In a case where the acquisition unit 122 acquires the scan information again, the extraction unit 124 verifies the new scan information, which is the newly acquired scan information, with the scan information history 1251. The extraction unit 124 verifies the new scan information with the scan information history 1251 using, for example, an image recognition technique. The extraction unit 124 may verify the new scan information with the scan information history 1251 based on configurations of a plurality of labels, configurations of items included in each label, or description contents in the items. Accordingly, the extraction unit 124 can determine whether the new scan information is content scanned in the past. In a case where the new scan information has not been scanned in the past, the extraction unit 124 extracts the target information according to the procedure described with reference to FIG. 1.

In the case of specifying the scan information history 1251 relevant to the new scan information, the extraction unit 124 extracts the target information of the target item based on the work identification information from the item information history 1252 associated with the scan information history 1251 relevant to the new scan information. Accordingly, the reading device 12 can reduce the calculation cost for detecting the target label and analyzing the description content of each item, and can efficiently read the content of the item suitable for the work content from the plurality of mixed labels.

The extraction unit 124 may limit the functions as described above to downstream work processes. The temporarily storing unit 125 may store the scan information history 1251 and the item information history 1252 only in the upstream work processes.

Specifically, it is assumed that the work process in the warehouse is executed in the order of incoming inspection, putting in shelves, picking, taking stock, shipping inspection, and packing. In this case, for example, the temporarily storing unit 125 stores the scan information history 1251 and the item information history 1252 in the incoming inspection process. The extraction unit 124 verifies the new scan information with the scan information history 1251, for example, in the processes of putting in shelves, picking, taking stock, shipping inspection, and packing. The extraction unit 124 is not limited thereto, and may verify the new scan information with the scan information history 1251 in a process after the target label is reliably read. Accordingly, the reading device 12 can efficiently store and read label information.

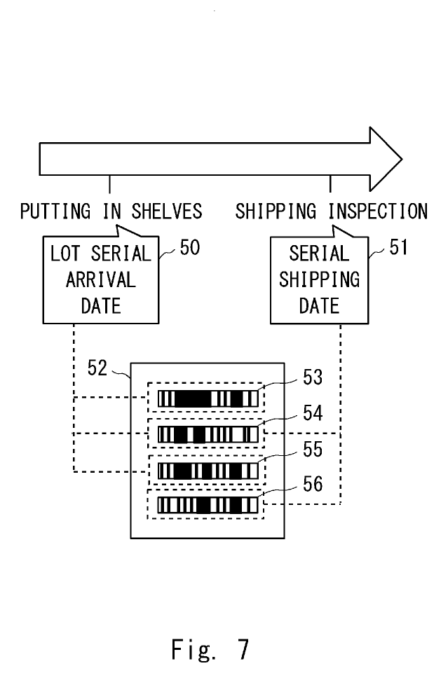

FIG. 7 is an example of a target label according to the present disclosure. FIG. 7 schematically illustrates a reading method of the reading device 12. An arrow shown in the upper part of FIG. 7 indicates the flow of the work process. Here, it is illustrated that the process of putting in shelves is executed in a process upstream of the shipping inspection process.

A first target item 50 is a target item in the process of putting in shelves. The first target item 50 indicates that information of the lot, the serial, and the arrival date is necessary for the shelving work. A second target item 51 is a target item in the shipping inspection process. The second target item 51 indicates that information of the serial and shipping date is necessary for shipping inspection work.

Here, a target label 52 is a label including target item information necessary in the processes of putting in shelves and shipping inspection. The target label 52 is common in the processes of putting in shelves and shipping inspection. The target label 52 is a label including a first item 53 indicating lot information, a second item 54 including serial information, a third item 55 indicating arrival date information, and a fourth item 56 including shipping date information. Here, the first item 53, the second item 54, the third item 55, and the fourth item 56 are all described by one-dimensional codes.

In the process of putting in shelves, the extraction unit detects the target label 52 and extracts description contents of the first item 53, the second item 54, and the third item 55 which are target items. Here, the temporarily storing unit temporarily stores the scan information history and the item information history 1252 including the description contents of the first item 53, the second item 54, the third item 55, and the fourth item 56 in association with each other in the process of putting in shelves which is an upstream process of the work.

In the shipping inspection process, the extraction unit verifies the new scan information with the scan information history. In a case where the new scan information and the scan information history are relevant to each other, the extraction unit reads the item information history from the temporarily storing unit, and extracts description contents of the second item 54 and fourth item 56 relevant to the target item.

In a case where the item information history is read in the most downstream process, the temporarily storing unit may delete the scan information history and item information history temporarily stored. The temporarily storing unit may delete the scan information history and the item information history temporarily stored after a certain period of time. The certain period is a period from the arrival of an article in a normal warehouse to the exhibition of the article. The certain period is, for example, one day, one week, one month, or the like, but is not limited thereto. Further, the temporarily storing unit may delete the scan information history and item information history temporarily stored in a case where a used capacity of a storage means (not illustrated) included in the temporarily storing unit exceeds a threshold. The threshold is, for example, 80% or 90% of the storage capacity of the storage means, but is not limited thereto, and may be arbitrarily set.

### Example of Hardware Configuration

Hereinafter, an example of a case where each functional component of the reading device in the present disclosure is implemented by a combination of hardware and software will be described.

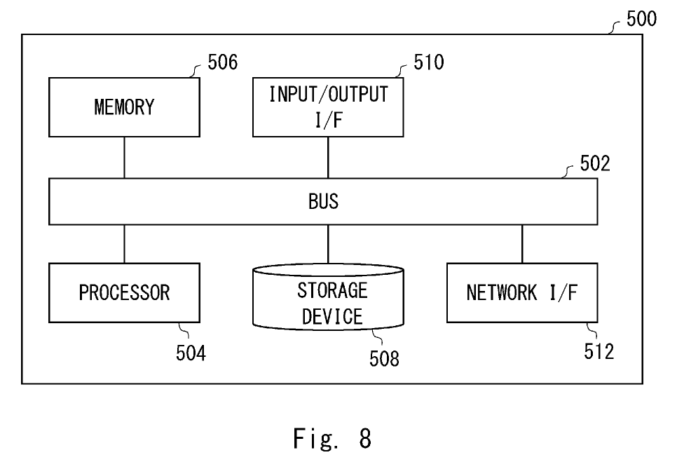

FIG. 8 is a block diagram illustrating a hardware configuration of a computer. A reading device according to the present disclosure can implement the above-described functions by using a computer 500 having the hardware configuration illustrated in the diagram. The computer 500 may be a portable computer such as a smartphone or a tablet terminal or may be a stationary computer such as a PC. The computer 500 may be a dedicated computer designed to implement each device, or may be a general-purpose computer. The computer 500 can implement a desired function by installing a predetermined application.

The computer 500 includes a bus 502, a processor 504, a memory 506, a storage device 508, an input/output interface (I/F) 510, and a network interface (I/F) 512. The bus 502 is a data transmission path for the processor 504, the memory 506, the storage device 508, the input/output interface 510, and the network interface 512 to transmit and receive data to and from each other. However, a method of connecting the processor 504 and the like to each other is not limited to the bus connection.

The processor 504 is any of various processors such as a CPU, a GPU, or an FPGA. The memory 506 is a primary storage device achieved using a Random Access Memory (RAM) or the like.

The storage device 508 is an auxiliary storage device achieved using a hard disk, an SSD, a memory card, a Read Only Memory (ROM), or the like. The storage device 508 stores a program for implementing a desired function. The processor 504 reads the program into the memory 506 and executes the program to implement each functional component of each of the devices.

The input/output interface 510 is an interface for connecting the computer 500 and an input/output device. For example, an input device such as a keyboard and an output device such as a display device are connected to the input/output interface 510. The network interface 512 is an interface for connecting the computer 500 to a network.

The programs described above can be stored and supplied to computers using various types of non-transitory computer readable media. The non-transitory computer readable media include various types of tangible storage media. Examples of the non-transitory computer readable media include magnetic storage media (such as floppy disks, magnetic tapes, hard disk drives, or the like), optical magnetic storage media (for example, magneto-optical disks), CD-ROM, CD-R, CD-R/W, and semiconductor memories (such as mask ROM, PROM (Programmable ROM), EPROM (Erasable PROM), flash ROM, RAM, or the like). The programs may also be supplied to the computer by various types of transitory computer readable media. Examples of the transitory computer readable media include electrical signals, optical signals, and electromagnetic waves. The transitory computer readable media can supply programs to computers via wired or wireless communication paths, such as wires and optical fiber.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with other embodiments.

The first, second, and third embodiments can be combined as desirable by one of ordinary skill in the art. While the disclosure has been particularly shown and described with reference to embodiments thereof, the disclosure is not limited to these embodiments. It will be understood by those of ordinary skill in the art that various changes in form and details may be made therein without departing from the spirit and scope of the present disclosure as defined by the claims.

Each of the drawings is merely an example to illustrate one or more example embodiments. Each of the drawings is not associated with only one specific example embodiment, but may be associated with one or more other example embodiments. As those of ordinary skill in the art will appreciate, various features or steps described with reference to any one of the figures may be combined with features or steps shown in one or more other figures, for example, to create example embodiments that are not explicitly illustrated or described. All of the features or steps shown in any one of the figures for describing the exemplary example embodiments are not necessarily mandatory, and some features or steps may be omitted. The order of the steps described in any one of the drawings may be changed as appropriate.

Some or all of the above example embodiments can also be described as the following Supplementary Notes, but are not limited to the following Supplementary Notes.

### Supplementary Note 1

A reading device including:

a storage unit that stores work identification information for identifying work content and target item information indicating a target item included in a target label necessary for execution of the work content in association with each other;

an acquisition unit that acquires scan information indicating information obtained by collectively reading a plurality of labels attached to an article;

a specification unit that acquires work information related to work to be worked on by a worker, and specifies the work identification information relevant to the work information; and

an extraction unit that detects the target label from the plurality of labels of the scan information based on the target item information associated with the specified work identification information, and extracts description contents of the target item from the target label as target information.

### Supplementary Note 2

The reading device according to Supplementary Note 1, in which

the target item information includes feature information indicating a format of the target label, and

the extraction unit is configured to execute: detecting the target label based on the feature information from the plurality of labels included in the scan information.

### Supplementary Note 3

The reading device according to Supplementary Note 1 or 2, in which

the storage unit further stores registration information in which the worker is identifiably registered in association with the work identification information,

the acquisition unit acquires authentication information related to authentication of the worker, and

the specification unit specifies the work identification information based on the authentication information and the registration information.

### Supplementary Note 4

The reading device according to Supplementary Note 3, in which

the storage unit stores schedule information indicating a work schedule for each worker in further association with the registration information, and

the specification unit further acquires a current time, and specifies the work identification information based on the authentication information, the registration information, the schedule information, and the current time.

### Supplementary Note 5

The reading device according to Supplementary Note 1 or 2, in which

the acquisition unit acquires selection information indicating the work content selected by the worker, and

the specification unit specifies the work identification information relevant to the work content indicated by the selection information.

### Supplementary Note 6

The reading device according to Supplementary Note 1 or 2, in which

the storage unit further stores terminal identification information of a read terminal that reads the plurality of labels in association with the work identification information,

the acquisition unit acquires the terminal identification information via communication with the read terminal that has generated the scan information, and

the specification unit specifies the work identification information based on the terminal identification information of the read terminal that has generated the scan information.

### Supplementary Note 7

The reading device according to Supplementary Note 1 or 2, in which

the scan information includes scan position information indicating a position at which the plurality of labels have been read,

the storage unit further stores work position information indicating a work area for each work content in association with the work identification information, and

the specification unit specifies the work identification information based on the scan position information included in the scan information.

### Supplementary Note 8

The reading device according to Supplementary Note 1 or 2, further including a temporarily storing unit that temporarily stores a scan information history as the scan information acquired in a past in association with an item information history indicating description contents of an item including at least the target item of the target label detected in the scan information in a past,

in which the extraction unit is configured to execute:

verifying new scan information that is the newly acquired scan information with the scan information history; and

extracting the target information of the target item based on the work identification information from the item information history associated with the scan information history relevant to the new scan information.

### Supplementary Note 9

A reading method including:

storing work identification information for identifying work content and target item information indicating a target item included in a target label necessary for execution of the work content in association with each other;

acquiring scan information indicating information obtained by collectively reading a plurality of labels attached to an article;

acquiring work information related to work to be worked on by a worker, and specifying the work identification information relevant to the work information; and

detecting the target label from the plurality of labels of the scan information based on the target item information associated with the specified work identification information, and extracting description contents of the target item from the target label as target information.

### Supplementary Note 10

A program for causing a computer to execute:

storing work identification information for identifying work content and target item information indicating a target item included in a target label necessary for execution of the work content in association with each other;

acquiring scan information indicating information obtained by collectively reading a plurality of labels attached to an article;

acquiring work information related to work to be worked on by a worker, and specifying the work identification information relevant to the work information; and

detecting the target label from the plurality of labels of the scan information based on the target item information associated with the specified work identification information, and extracting description contents of the target item from the target label as target information.

Some or all of the elements (for example, configurations and functions) described in Supplementary Notes 2 to 8 dependent on Supplementary Note 1 can also depend on Supplementary Notes 9 and 10 in a similar dependency relationship as Supplementary Notes 2 to 8. Some or all of the elements that have been described in any Supplementary Note are applicable to various types of hardware, software, recording means for recording software, systems, and methods.

What is claimed is:

1. A reading apparatus comprising:
at least one memory storing instructions; and
at least one processor configured to execute the instructions to:
store work identification information for identifying work content and target item information indicating a target item included in a target label necessary for execution of the work content in association with each other;
acquire scan information indicating information obtained by collectively reading a plurality of labels attached to an article;
acquire work information related to work to be worked on by a worker, and specify the work identification information relevant to the work information; and
detect the target label from the plurality of labels of the scan information based on the target item information associated with the specified work identification information, and extract description contents of the target item from the target label as target information.

2. The reading apparatus according to claim 1, wherein
the target item information includes feature information indicating a format of the target label, and
the at least one processor detects the target label based on the feature information from the plurality of labels included in the scan information.

3. The reading apparatus according to claim 1, wherein the at least one processor
further stores registration information in which the worker is identifiably registered in association with the work identification information;
acquires authentication information related to authentication of the worker; and
specifies the work identification information based on the authentication information and the registration information.

4. The reading apparatus according to claim 3, wherein the at least one processor
stores schedule information indicating a work schedule for each worker in further association with the registration information; and
further acquires a current time, and specifies the work identification information based on the authentication information, the registration information, the schedule information, and the current time.

5. The reading apparatus according to claim 1, wherein the at least one processor
acquires selection information indicating the work content selected by the worker; and
specifies the work identification information relevant to the work content indicated by the selection information.

6. The reading apparatus according to claim 1, wherein the at least one processor
further stores terminal identification information of a read terminal that reads the plurality of labels in association with the work identification information;
acquires the terminal identification information via communication with the read terminal that has generated the scan information; and
specifies the work identification information based on the terminal identification information of the read terminal that has generated the scan information.

7. The reading apparatus according to claim 1, wherein
the scan information includes scan position information indicating a position at which the plurality of labels have been read, and
the at least one processor
further stores work position information indicating a work area for each work content in association with the work identification information; and
specifies the work identification information based on the scan position information included in the scan information.

8. The reading apparatus according to claim 1, wherein the at least one processor
temporarily stores a scan information history as the scan information acquired in a past in association with an item information history indicating description contents of an item including at least the target item of the target label detected in the scan information in a past;
verifies new scan information that is the newly acquired scan information with the scan information history; and
extracts the target information of the target item based on the work identification information from the item information history associated with the scan information history relevant to the new scan information.

9. A reading method comprising:
storing work identification information for identifying work content and target item information indicating a target item included in a target label necessary for execution of the work content in association with each other;
acquiring scan information indicating information obtained by collectively reading a plurality of labels attached to an article;
acquiring work information related to work to be worked on by a worker, and specifying the work identification information relevant to the work information; and
detecting the target label from the plurality of labels of the scan information based on the target item information associated with the specified work identification information, and extracting description contents of the target item from the target label as target information.

10. A non-transitory computer readable medium storing a program for causing a computer to execute a reading method, the reading method including:
storing work identification information for identifying work content and target item information indicating a target item included in a target label necessary for execution of the work content in association with each other;
acquiring scan information indicating information obtained by collectively reading a plurality of labels attached to an article;
acquiring work information related to work to be worked on by a worker, and specifying the work identification information relevant to the work information; and
detecting the target label from the plurality of labels of the scan information based on the target item information associated with the specified work identification information, and extracting description contents of the target item from the target label as target information.
